(19) United States
(12) Patent Application Publication
(10) Pub. No.: US 2014/0043653 A1
(43) Pub. Date: Feb. 13, 2014

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Naoki Oyama, Yokohama-shi (JP)

(73) Assignee: CANON KABUSHIKI KAISHA, Tokyo (JP)

(21) Appl. No.: 13/959,322

(22) Filed: Aug. 5, 2013

(30) Foreign Application Priority Data
Aug. 7, 2012 (JP) 2012-174852

(51) Int. Cl. G06K 15/02; H04N 1/21

(52) U.S. Cl. CPC G06K 15/183; H04N 1/2166
USPC 358/1.16

(57) ABSTRACT

An image processing apparatus includes a storage unit that stores management information about image processing of data recorded on a recording medium connected to the image processing apparatus, a reading unit that reads data from the recording medium, an image processing unit that performs image processing on the read data, and a control unit that controls reading of the data from the recording medium and the image processing according to the management information, wherein the control unit causes the reading unit, when it is detected that connection with the recording medium has been disconnected and image processing of a number of times specified by the management information is not completed, to read the data in response to detection of connection with the recording medium, and causes the image processing unit to execute image processing of a remaining number of times out of the specified number of times.

### BACKGROUND

1. Field

Aspect of the present invention generally relate to an image processing apparatus, an image processing method, and a storage medium.

2. Description of the Related Art

Conventionally, a memory card, a universal serial bus (USB) memory, and the like have been used for a personal computer, a digital camera, and the like. Further, in printing apparatuses, a model for mounting a hard disk (HDD) has conventionally existed. In these days, there is known a printing apparatus that can print data in portable document format (PDF) or extensible markup language paper specification (XPS), and the like, by directly inserting a USB memory into the printing apparatus.

The USB memory is vulnerable to static electricity from the outside, and the USB memory may be disconnected for a moment due to static electricity.

While a user is setting up a file which the user wants to print, print characteristics, the number of sheets to print, and the like, by using a user interface (UI) in order to print from the USB memory, the USB memory may go into disconnected state due to static electricity or the like from the outside. Consequently, the USB memory may go into unreadable status, and the user may need to perform resetting.

Japanese Patent Application Laid-Open No. 2011-008402 discusses a technique for enabling, even when an external device connected to an information processing apparatus via an interface is temporarily disconnected and reconnected, the information processing apparatus to access the external device based on a connected state before disconnection is discussed.

However, in a case where a printer which does not mount a large capacity memory such as a HDD performs printing of a plurality of copies, based on data stored in the USB memory, the printer performs readouts of the data from the USB memory the same number of times as the number of copies to print.

Therefore, when the USB memory is once disconnected due to static electricity or the like while printing a plurality of copies, printing will be stopped even if printing of specified number of copies has not been completed.

### SUMMARY

According to an aspect of the present invention, an image processing apparatus includes a storage unit configured to store management information about image processing of data recorded on a recording medium connected to the image processing apparatus, a reading unit configured to read data recorded on the recording medium, an image processing unit configured to perform image processing on the data read by the reading unit, and a control unit configured to control reading of the data from the recording medium and the image processing according to the management information stored in the storage unit, wherein the control unit causes, in a case where it is detected that connection with the recording medium has been disconnected and image processing of a number of times specified by the management information stored in the storage unit is not completed, the reading unit to read the data in response to detection of connection with the recording medium, and causes the image processing unit to execute image processing of a remaining number of times out of the specified number of times.

According to the present disclosure, an image processing apparatus is capable of, while reading data from a recording medium connected to the image processing apparatus and performing image processing for a plurality of copies, completing image processing for a specified number of times, even if connection with the recording medium is disconnected due to static electricity or the like.

Further features of the present disclosure will become apparent from the following detailed description of exemplary embodiments with reference to the attached drawings.

### BRIEF DESCRIPTION OF THE DRAWINGS

FIG. 1 is a diagram illustrating an example of a hardware configuration of a single function printer (SFP).

FIG. 2A is connection wiring diagram of a USB-H I/F, FIG. 2B is a diagram illustrating levels of signals when a USB memory normally accesses the USB-H I/F, FIG. 2C is a diagram illustrating a disconnected state of the USB memory, and FIG. 2D is a diagram illustrating a connected state of the USB memory.

FIG. 3 is a diagram illustrating a data path while the SFP is performing continuous printing of a plurality of copies from the USB memory.

FIG. 4 is a flowchart illustrating an example of general processing for stopping printing when the USB memory is disconnected due to static electricity or the like while the SFP is performing continuous printing of a plurality of copies.

FIG. 5 (5A+5B) is a flowchart (case 1) illustrating an example of print control processing according to an exemplary embodiment in a case where the USB memory is disconnected due to static electricity or the like while the SFP is performing continuous printing of a plurality of copies.

FIG. 6 is a diagram illustrating an example of a management table.

FIG. 7A is a timing chart in a case where printing could be properly performed. FIG. 7B is a timing chart in a case where disconnection of the USB memory has occurred while printing of the second page is in progress, and printing is resumed after waiting for 5 seconds as defined previously after printing of the third page is completed. FIG. 7C is a timing chart in a case where the USB memory is disconnected, and printing is resumed after waiting for 5 seconds since then.

FIG. 8 (8A+8B) is a flowchart (case 2) illustrating an example of print control processing according to an exemplary embodiment in a case where the USB memory is disconnected due to static electricity or the like while the SFP is performing continuous printing of a plurality of copies.

FIG. 9A is a timing chart in a case where printing could be properly performed. FIG. 9B is a timing chart in a case where reading of the second data for 5 pages is performed, and disconnection of the USB memory is detected just when printing of the ninth page is performed.

FIG. 9C is a timing chart in a case where disconnection of the USB memory is detected at a timing a little earlier than that in FIG. 9B, and an interruption of printing cannot be recognized from a user.

### DESCRIPTION OF THE EMBODIMENTS

Hereinbelow, exemplary embodiments will be described with reference to the drawings.

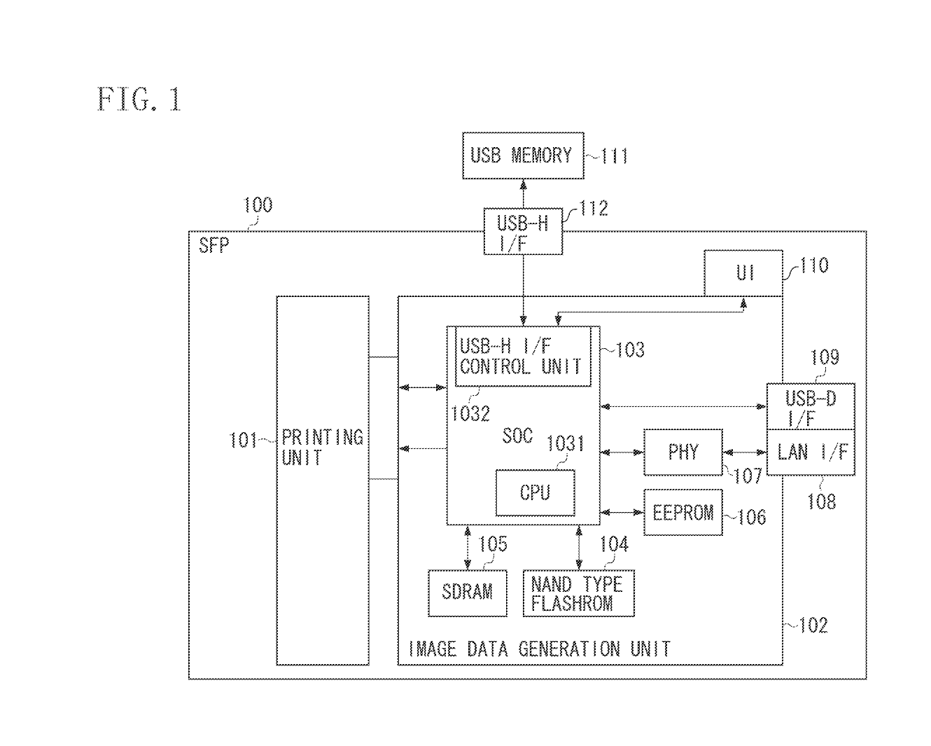

FIG. 1 is a diagram illustrating an example of a hardware configuration of a single function printer (SFP).

An SFP 100 includes a printing unit 101, and an image data generation unit 102. The SFP 100 is an example of an image processing apparatus. In the present exemplary embodiment, description will be given using the SFP as an example of the image processing apparatus, but a multifunction peripheral (MFP) having functions other than print function may be used.

The printing unit 101 performs printing on a paper sheet, based on image data generated by the image data generation unit 102 by using a printing process such as an electrophotographic process or inkjet process.

The image data generation unit 102 converts print request data from a personal computer (hereinafter, referred to as PC) or the like into image data, to thereby convert into data compatible with the printing unit 101, and it is generally called a printer controller.

A user interface (UI) 110 is used by a user to suitably set up the SFP 100 to match own usage purpose, and it is also called an operation panel.

The image data generation unit 102 includes a system on chip (hereinafter, referred to as SOC) 103, a NAND-type flash read only memory (ROM) 104, a synchronous dynamic random access memory (SDRAM) 105, an electrically erasable programmable read-only memory (EEPROM) 106, a physical layer (PHY) 107, a local area network (LAN) I/F 108, and a USB-D I/F USB device (USB-D) interface (I/F) 109. Further, the image data generation unit 102 includes a USB host (USB-H) interface (I/F) 112.

Further, the SOC 103 includes a central processing unit (CPU) 1031, and a USB host interface (USB-H I/F) control unit 1032.

The SOC 103 is an integrated circuit. The CPU 1031 reads a program stored in the NAND type Flash ROM 104, loads the program onto the SDRAM 105, and executes the processing while using the SDRAM 105 as a temporary storage area. Through thus operation, the functions of the SOC 103 (or the image data generation unit 102), and the processing related to the flowcharts described below are realized.

The SOC 103 performs control of the USB-H interface control unit 1032, memory control, control of communication with the printing unit 101 and image data transfer, and control (image processing control) of printing in the printing unit 101, based on the control of the CPU 1031. Further, the SOC 103 performs control of an external interface or the like of the USB or the LAN for receiving print request data from PC, based on the control of the CPU 1031.

The EEPROM 106 is a nonvolatile memory which can retain necessary information even if power of the SFP 100 is not supplied.

The PHY 107 is a driver receiver IC for data communication of a network (LAN).

The LAN I/F 108 is an interface of the LAN (network).

The USB-D I/F 109 is a serial interface that can exchange data at a high speed of 480 Mbit/sec. A USB memory 111 can store document data in portable document format (PDF) or extensible markup language (XML) paper specification (XPS). The USB memory 111 is an example of a recording medium, and the USB memory 111 is attachable to and detachable from the SFP 100 via the USB-H I/F 112.

The SFP 100 can print out, in a case where the USB memory 111 stores document data in PDF or XPS, directly a file of the document data in PDF or XPS in the USB memory 111, based on settings by the user via the UI 110.

The USB-H I/F 112 is a USB 2.0 host interface that connects the USB memory 111 and the SOC 103, and is a serial interface that can exchange data at a high speed of 480 Mbit/sec.

The USB-H I/F 112 includes a USB host as a master and a USB device as a servant, and the data transfer is performed at an initiative of the USB host side.

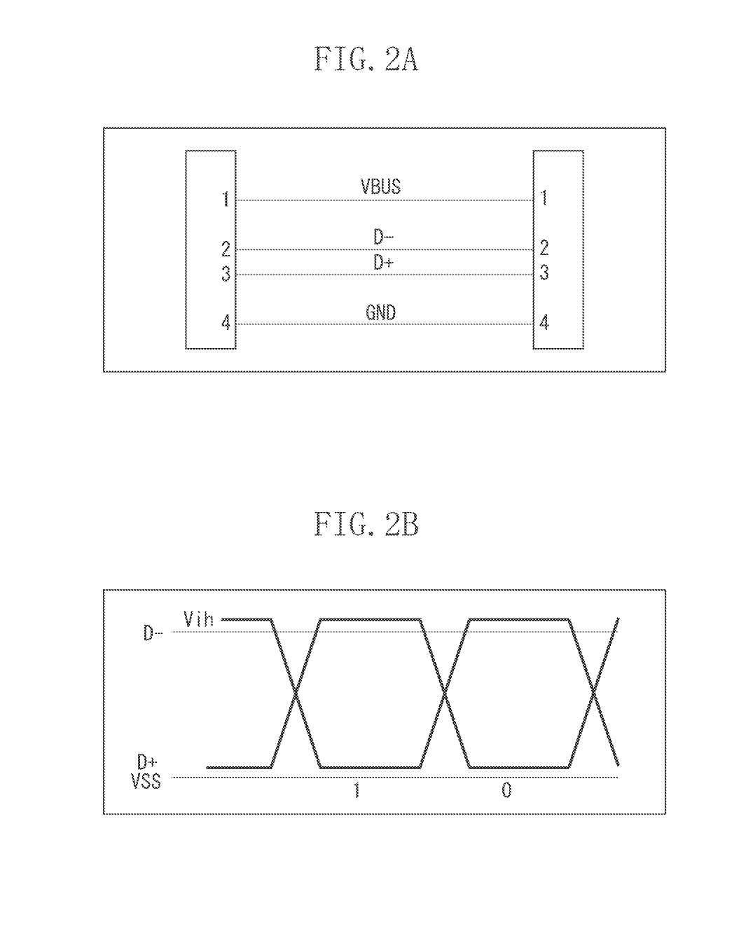

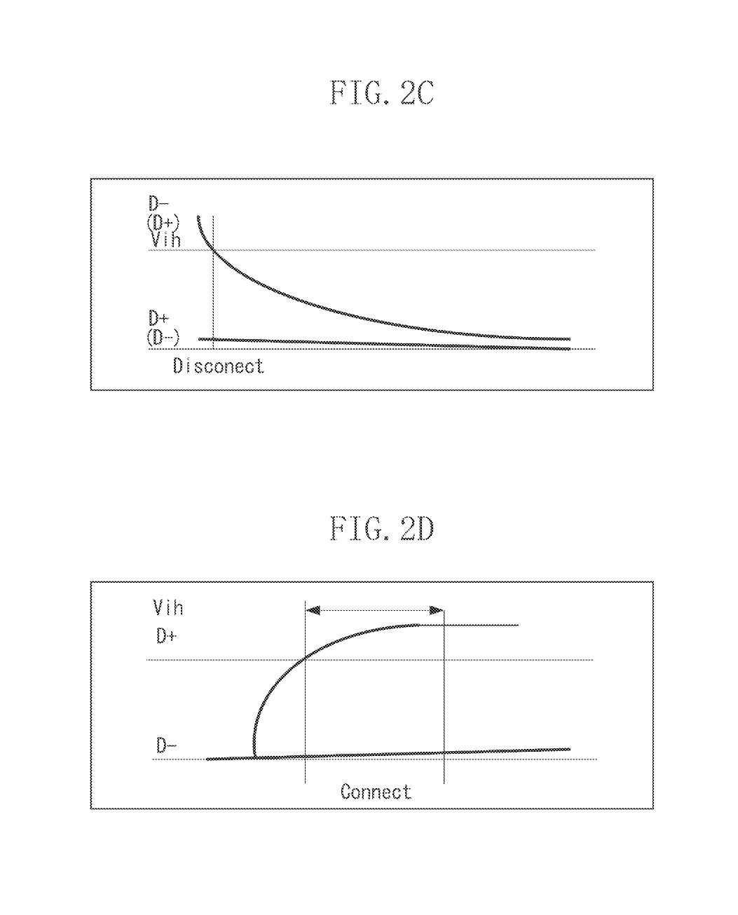

FIGS. 2A through FIG. 2D are diagrams illustrating the USB-H I/F 112. FIG. 2A is a connection wiring diagram of the USB-H I/F 112. Pin 1 is 5V used as VBUS for supplying power to the USB memory 111, pin 2 as D− signal, pin 3 as D+ signal, pin 4 as GND (VSS). The D+ signal and D− signal are used as two differential signals.

FIG. 2B is a diagram illustrating levels of signals, in a case where the USB memory 111 is properly connected to the USB-H I/F 112. Using two signals of D+, and D−, 1 and 0 is represented in digital. More specifically, when D− is H and D+ is L, they represent “1”, and when D− is L and D− is H, they represent “0”.

FIG. 2C is a diagram illustrating a state where the USB memory 111 is disconnected from the USB-H I/F 112. When either D+ or D− signal is not Vih, and the state continues for a certain period of time, it is recognized as disconnected. The Vih is a minimum guarantee voltage for recognizing as “H” in a case where specified signal has equal to or greater than an electric potential thereof. When the USB memory 111 is disconnected due to static electricity, any signal of D+ and D− will become L by influence of the static electricity, and consequently the SFP 100 recognizes that the USB memory 111 has been disconnected. The same is true when the USB memory 111 has been disconnected from the USB-H I/F 112. Further, as for the connected state, when a state where D+ has exceeded Vih continues for a certain period of time as illustrated in FIG. 2D, the USB memory 111 is regarded as connected, and the USB-H I/F starts initialization. FIG. 2D is a diagram illustrating the connected state of the USB memory 111.

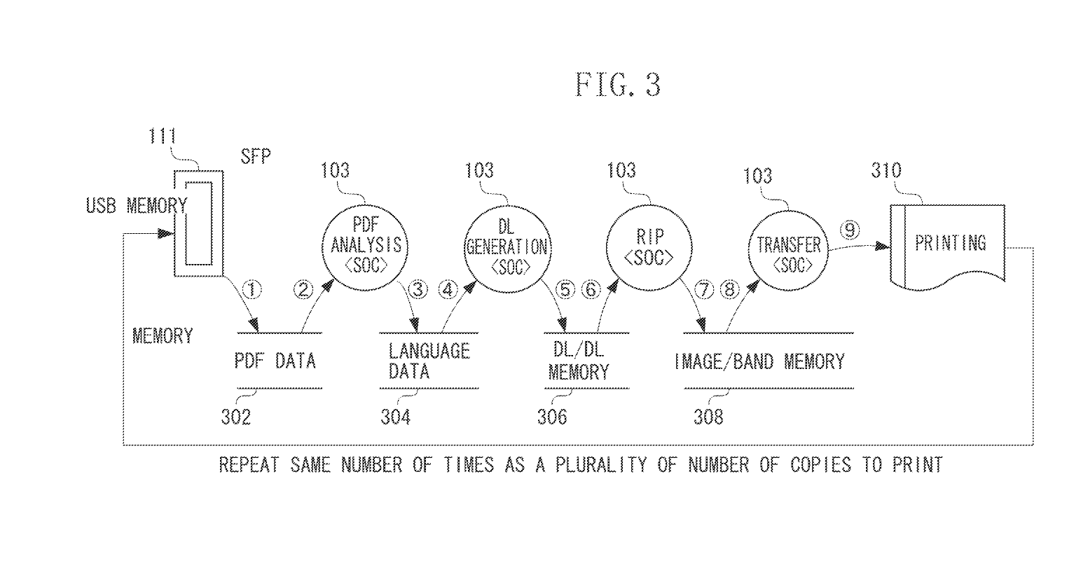

FIG. 3 is a diagram illustrating a data path when the SFP 100 performs continuous printing of a plurality of copies, based on PDF data 302 stored in the USB memory 111.

The CPU 1031 in the SOC 103 reads PDF data 302 from the USB memory 111 of the SFP 100, and transfers the PDF data 302 to the SDRAM 105. The CPU 1031 analyzes the PDF data, and converts into PDL language data 304. Next, the CPU 1031 in the SOC 103 generates a display list (DL), and stores a DL 306 in the SDRAM 105. Next, the CPU 1031 performs raster image processing (RIP) inside the SOC 103, and generates image data 308, and stores the image data 308 in the SDRAM 105. Next, hardware inside the SOC 103 transfers the image data to the printing unit 101, and causes the printing unit 101 to output the image data on a paper sheet (310).

When a plurality of copies is printed out, the above-described processing is repeated. In other words, image processing is repeatedly executed the same number of times as the specified number of copies.

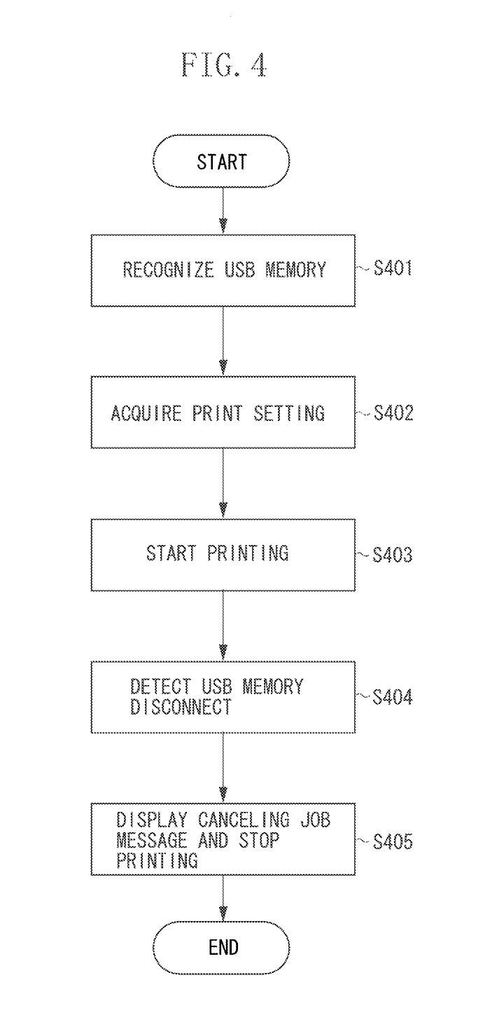

FIG. 4 is a flowchart illustrating an example of general processing in which the SFP 100 stops printing when the USB memory 111 is disconnected due to static electricity or the like while the SFP 100 is currently printing a plurality of copies.

In step S401, the CPU 1031 accesses the USB memory 111 to recognize the USB memory 111, through the USB-H I/F 112.

In step S402, the CPU 1031 acquires (or recognizes) information set by the user, via the UI 110. For example, the CPU 1031 acquires print setting information or the like, via the UI 110.

In step S403, the CPU 1031 controls start of printing of data stored in the USB memory 111.

If the disconnected state occurs due to static electricity or the like on the USB-H I/F 112 which connects the USB memory 111 and the USB-H I/F control unit 1032, then in step S404, the CPU 1031 detects that the USB memory 111 has been disconnected.

In step S405, the CPU 1031 displays a message indicating that “print job will be stopped” on the UI 110 and stops printing.

Detections of disconnection and connection of the USB memory 111 are as previously illustrated in FIGS. 2A through 2D.

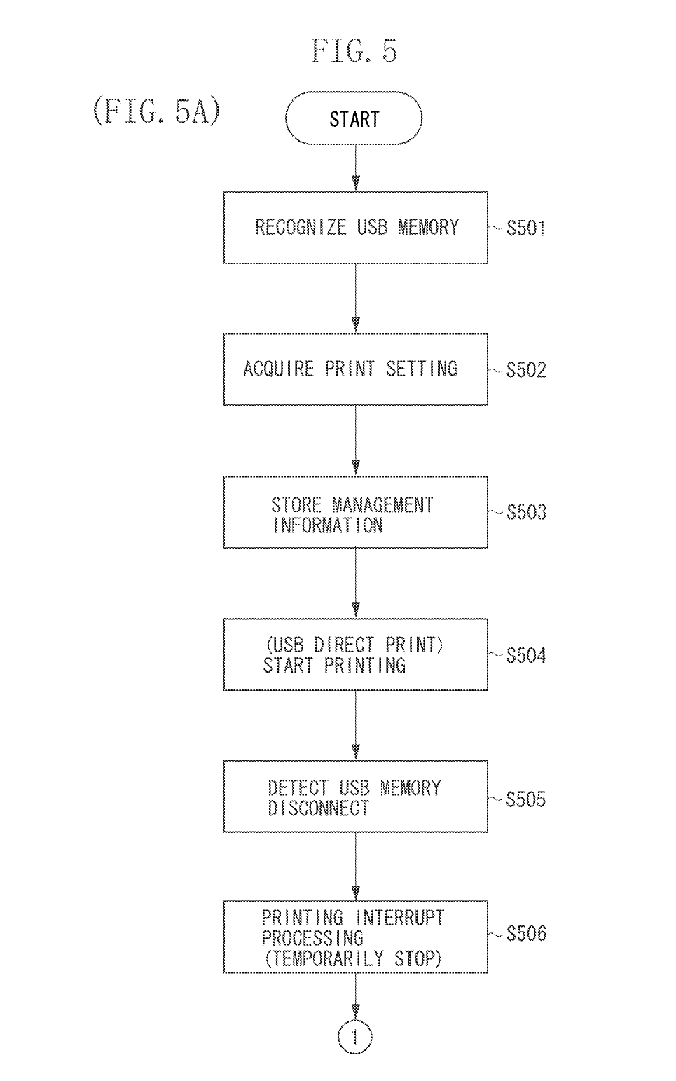

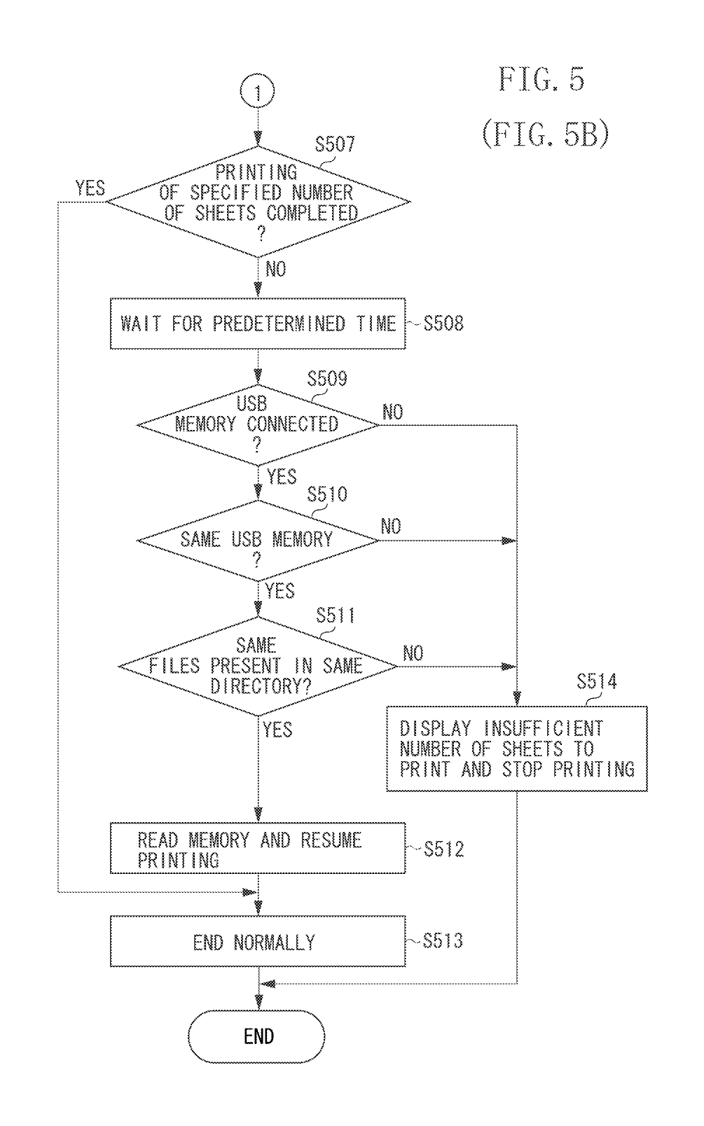

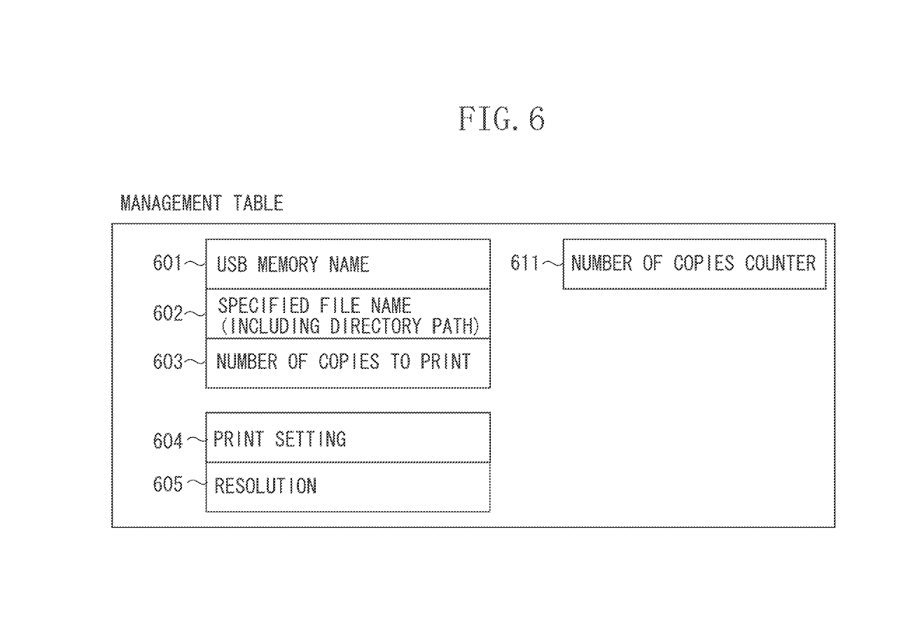

FIG. 5 is a flowchart (case 1) illustrating an example of print control processing according to the present exemplary embodiment in a case where the USB memory 111 is disconnected due to static electricity or the like while the SFP 100 is currently printing on a plurality of number of copies.

In step S501, the CPU 1031 accesses the USB memory 111 through the USB-H I/F 112, to recognize the USB memory 111.

In step S502, the CPU 1031 acquires a specified file of print data in the USB memory 111, or printing setting information such as the number of copies to print, specification of two-sided printing or resolution, via the UI 110. Further, the CPU 1031 acquires a memory name from the USB memory 111 recognized in step S501.

In step S503, the CPU 1031 stores information acquired in step S502 in a memory inside the SOC 103 as management information, or in the SDRAM 105 as a management table. Details of the management table are illustrated in FIG. 6 described below.

In step S504, the CPU 1031 reads data from the USB memory 111, and causes the printing unit 101 to print out the data.

When static electricity occurs on the USB memory 111 or the USB-H I/F 112, then in step S505, the CPU 1031 detects disconnection of the USB memory 111.

In step S506, the CPU 1031 instructs the printing unit 101 to interrupt printing (temporary stop).

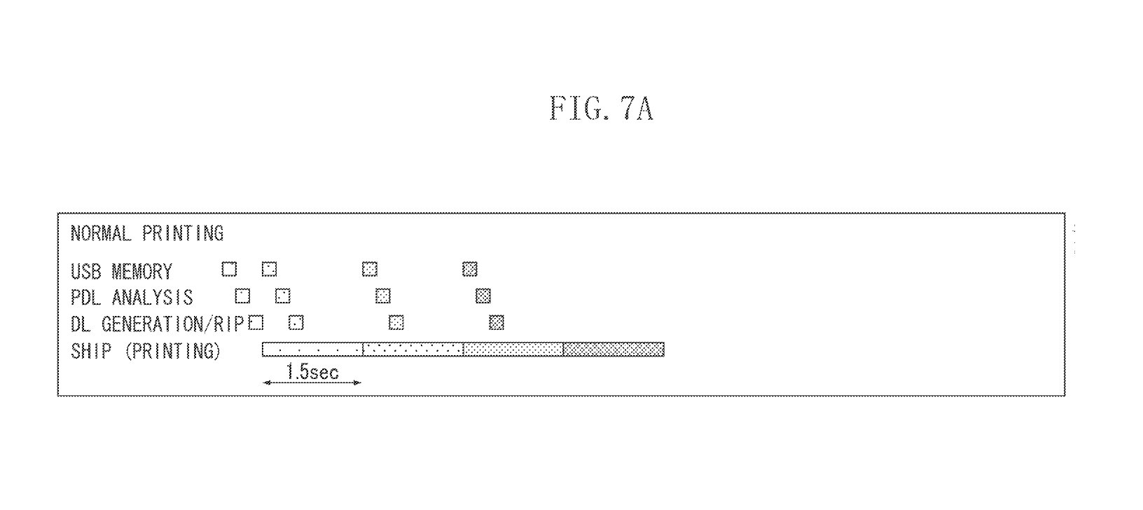

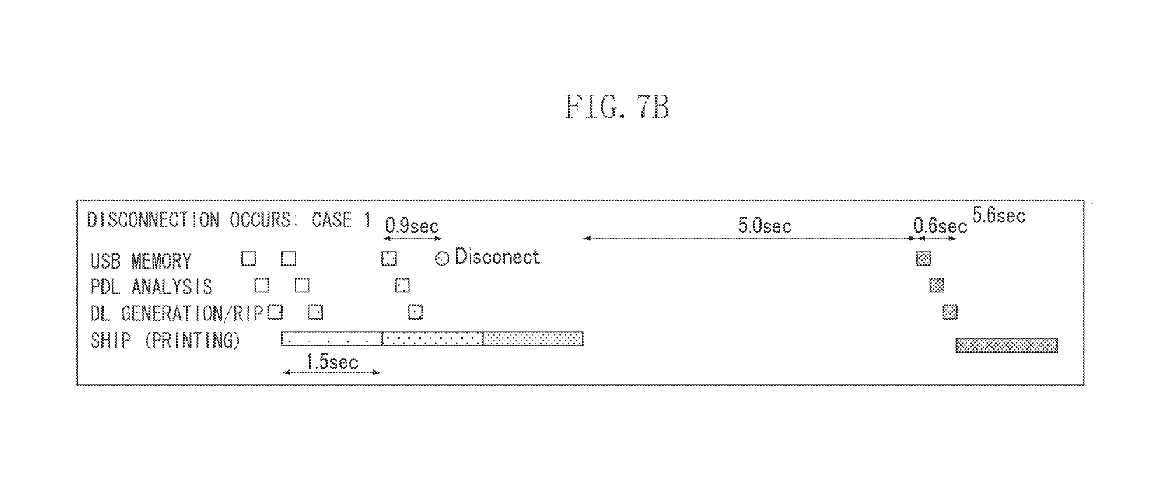

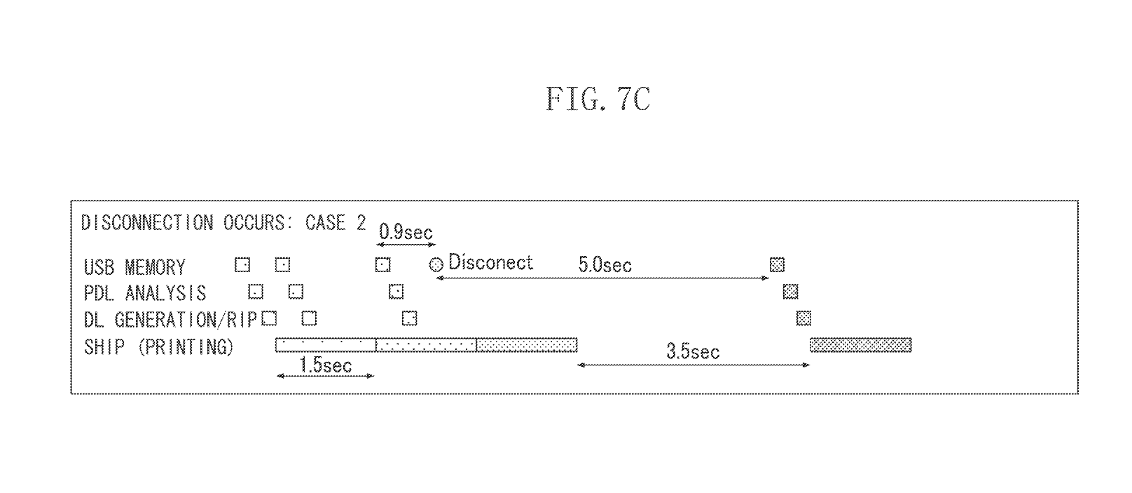

In step S507, the CPU 1031 compares a specified number of copies to print retained in the management table, and a counter (number of copies counter) of a number of printed copies which the CPU 1031 has counted as illustrated in FIGS. 7A, 7B, and 7C described below. Then, the CPU 1031 determines whether printing of a specified number of copies to print has been already completed. If the CPU 1031 determines that printing of the specified number of copies to print has been already completed (YES in step S507), the operation proceeds to step S513. If the CPU 1031 determines that printing of the specified number of copies to print has not been completed yet (NO in step S507), the operation proceeds to step S508.

In step S508, the CPU 1031 waits for the processing for a predetermined (or preset) time (e.g., 5 seconds).

If the USB memory 111 is connected to the USB-H I/F 112 again, then in step S509, the CPU 1031 detects connection of the USB memory 111, via the USB-H I/F 112. If the CPU 1031 has detected connection of the USB memory 111 (YES in step S509), the operation proceeds to step S510. If the CPU 1031 does not detect connection of the USB memory 111 (NO in step S509), the operation proceeds to step S514.

In step S510, the CPU 1031 acquires a memory name from the USB memory 111 which has been reconnected, and compares the acquired memory name and a memory name retained in the management table, to determine whether both memory names indicate the same memory. If the CPU 1031 determines that both memory names indicate the same memory (YES in step S510), the operation proceeds to step S511. If the CPU 1031 determines that both memory names does not indicate the same memory (NO in step S510), the operation proceeds to step S514.

In step S511, the CPU 1031 determines whether the same file names are present in the same directory of the USB memory 111 which has been reconnected, based on information of the specified file containing a directory path retained in the management table. If the CPU 1031 determines that the same file names are present in the same directory (YES in step S511), the operation proceeds to step S512. If the CPU 1031 determines that the same file names are not present in the same directory (NO in step S511), the operation proceeds to step S514.

In step S512, the CPU 1031 reads data from the USB memory 111, and causes the printing unit 101 to resume the rest of printing.

In step S513, the CPU 1031 normally ends the processing.

On the other hand, in step S514, the CPU 1031 warns and displays insufficient number of sheets (and/or a number of already printed sheets), based on a difference between the specified number of copies to print retained in the management table, and a number of copies counter, and displays that the job has been cancelled on the UI 110. Displaying a number of not-yet-printed sheets as a warning is only an example of warning. For example, in a case where the SFP 100 is equipped with a speaker, the CPU 1031 may output the warning via audio.

FIG. 6 is a diagram illustrating an example of the management table.

From a name 601 of connected USB memory 111, the CPU 1031 can recognize a manufacturer's name, manufacturer's model name, and the like. As information to be stored in the name 601, other information may be used as long as the information can identify the USB memory.

An image file name 602 is specified on the UI 110 by the user who wants to output it, and also includes a directory path.

A number of copies to print 603 is specified on the UI 110 by the user, and contains information of how many copies to print a specified file (information of a plurality of copies).

A print setting 604 is used to specify single-sided printing, or two-sided printing which the SFP 100 can perform. In the SFP 100 which cannot perform two-sided printing, setting of two-sided printing is disabled.

If a file cannot be specified by a resolution 605, display of an item for specifying a resolution on the UI 110 is disabled. Also, in the SFP 100 in which a plurality of resolutions cannot be specified, specification of the resolutions on the UI 110 is disabled.

A number of copies counter 611 is set when the CPU 1031 counts a properly printed number of copies.

FIGS. 7A, 7B, and 7C illustrate timing charts in a case where data of one page is printed for four copies.

FIG. 7A is a timing chart in a case where printing has been normally performed. FIG. 7B is a timing chart in a case where disconnection of the USB memory 111 has occurred while printing of the second page is in progress, and then printing of the fourth page is resumed after waiting for 5 seconds as previously defined just after printing of the third page is completed. FIG. 7C is a timing chart in a case where the USB memory 111 has been disconnected, and printing is resumed after waiting for 5 seconds from disconnection. The printing unit 101 related to the timing chart can perform single-sided printing of 40 pages per minute (ppm) with a resolution of 600 dpi, and can print out one sheet in 1.5 seconds.

FIG. 7A is a timing chart of normal printing, including reading first reading data from the USB memory 111, performing PDF analysis, DL generation, RIP, and transfer as described in FIG. 3, and resuming reading of the USB memory when operations up to RIP are completed.

FIG. 7B is a timing chart in a case where disconnection of the USB memory 111 due to static electricity or the like has been detected while printing of the second page is in progress and after reading the third page from the USB memory 111, and in a case of waiting for 5 seconds after completion of printing of the third page. Since the USB memory 111 can be actually reconnected in 5 seconds after disconnection of the USB memory 111 has been detected, 5 seconds is sufficient time, but the performance is lowered to some degree. It is assumed that it takes 0.2 seconds for reading from the USB memory 111, 0.2 seconds for PDL analysis, 0.2 seconds for DL generation/RIP, and 1.5 seconds for SHP. In this case, it takes 12.2 seconds in total for printing in FIG. 7B, and it takes 5.6 seconds even for a case where printing is resumed, while in a case of normal printing in FIG. 7A, it is completed in 6.6 seconds from the start.

Thus, if the SFP 100 is to wait for 5 seconds just after the USB memory 111 has been disconnected, it is only necessary to wait for 3.5 seconds before resuming printing, accordingly it takes only 10.1 seconds in total, as illustrated in FIG. 7C.

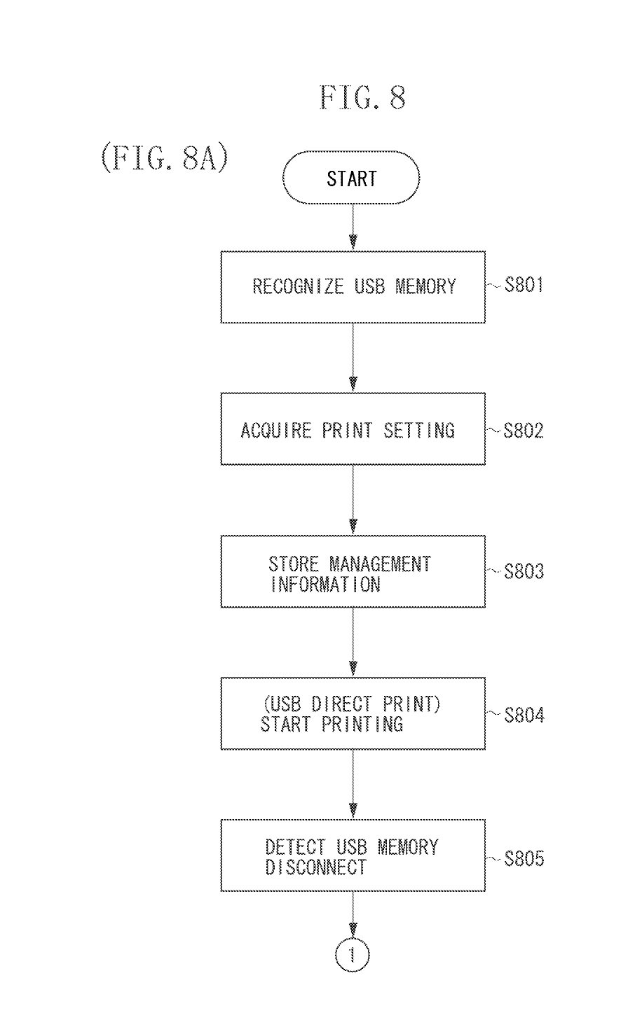

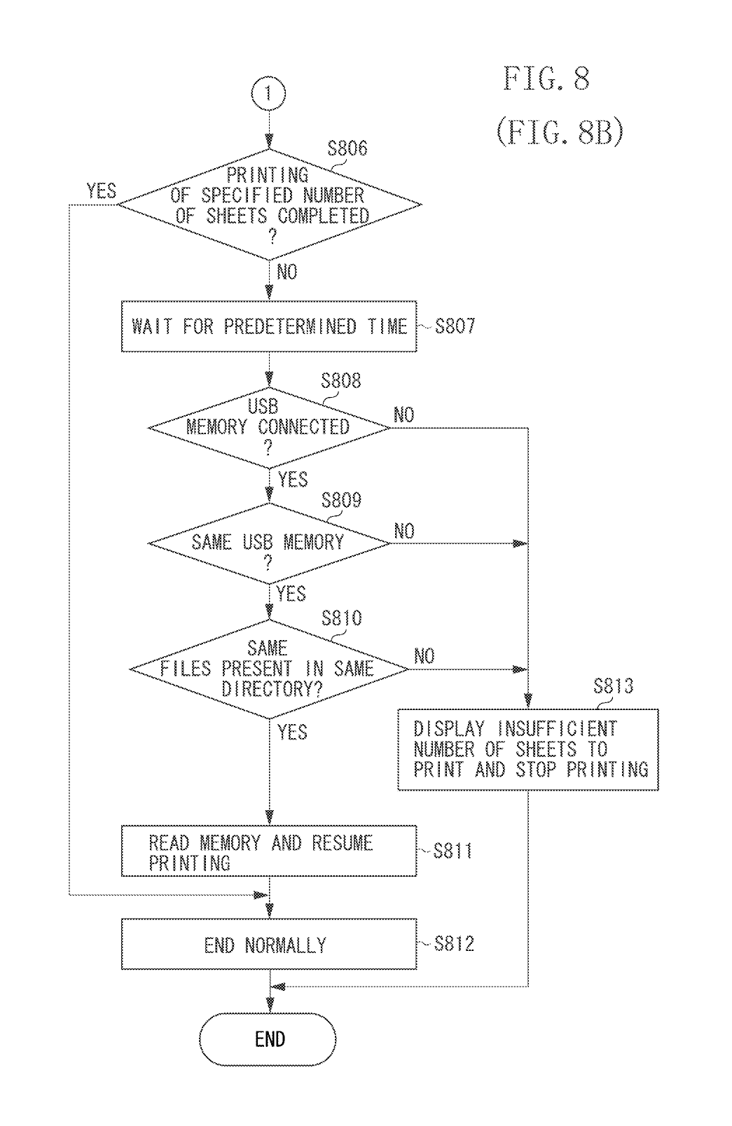

FIG. 8 is a flowchart (case 2) illustrating another example of print control processing according to the present exemplary embodiment in a case where the USB memory is disconnected due to static electricity or the like while the SFP 100 is currently printing out a plurality of copies.

In the processing in FIG. 8, when disconnection of the USB memory 111 occurs, printing stop is not performed, as compared with the processing in FIG. 5, and the CPU 1031 waits for the processing for a predetermined (or preset) time (e.g., 5 seconds) after confirming a number of printed-out sheets (after step S807). If the data which should be printed has been completely output (YES in step S806), the CPU 1031 ends the printing regardless of disconnection of the USB memory 111.

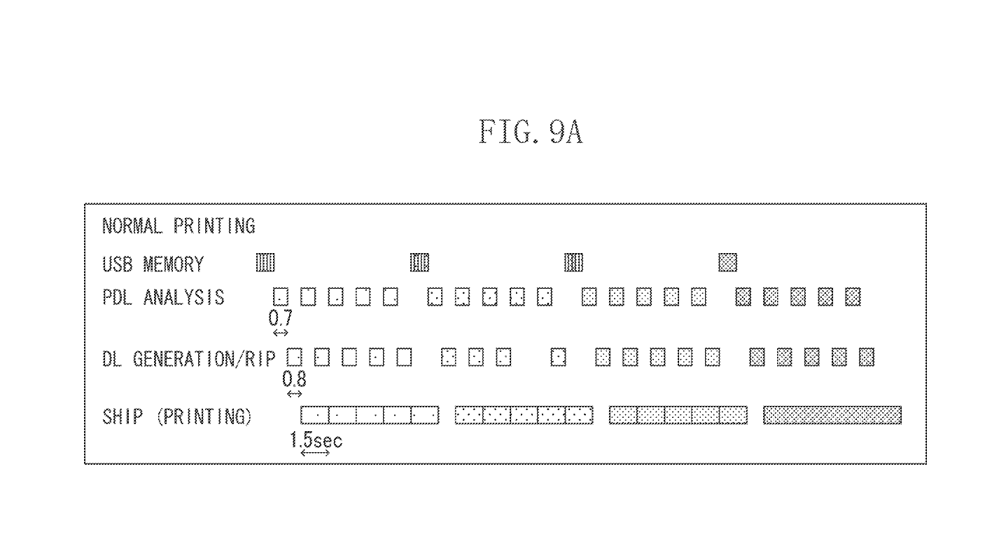

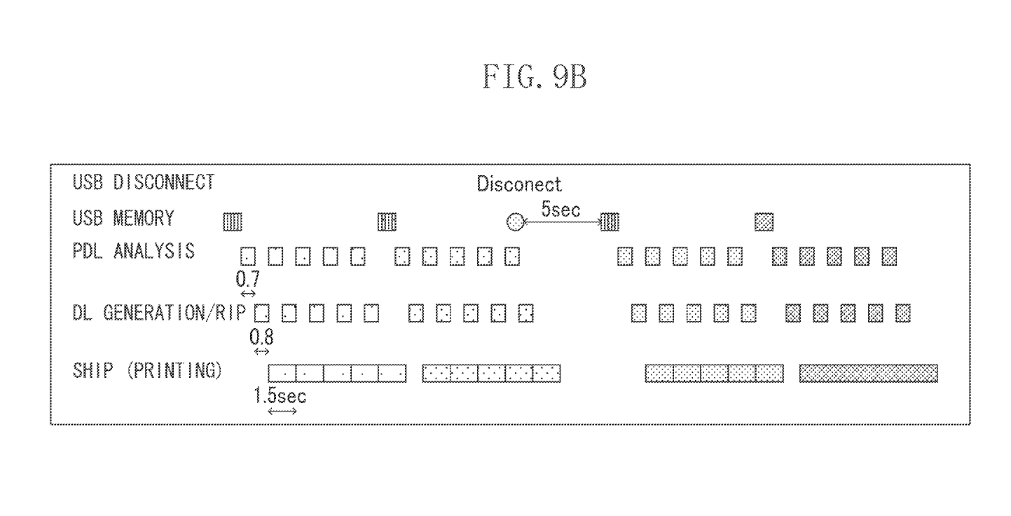

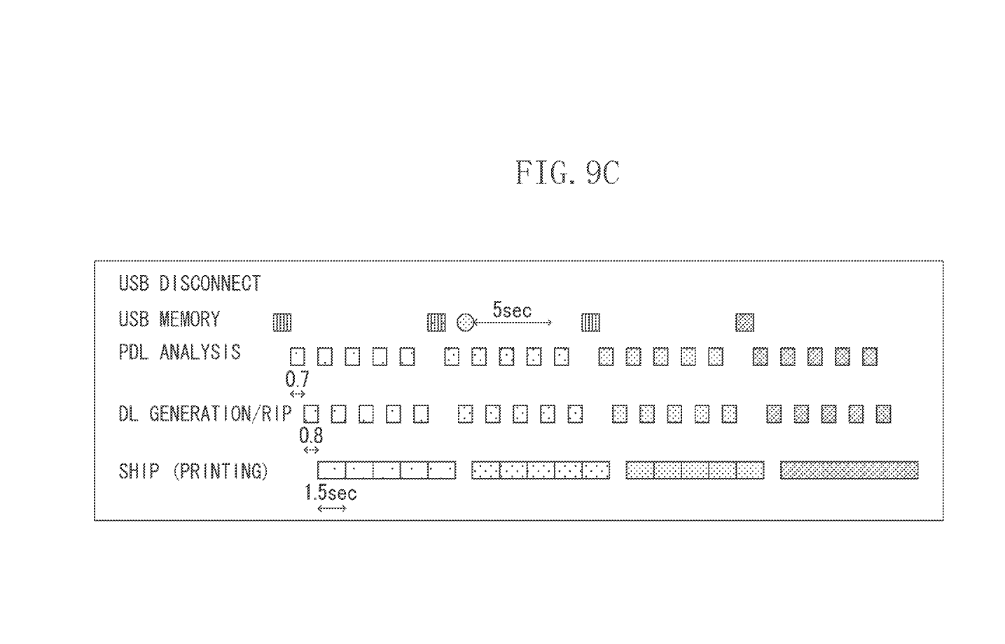

FIGS. 9A, 9B, and 9C are timing charts in a case of printing one copy of data for 20 pages.

FIG. 9A is a timing chart in a case where printing could be normally performed. The CPU 1031 reads data into a buffer of the USB memory 111 from the USB memory 111. It is assumed that the data for about 5 pages has been stored in the buffer. Since the PDF analysis and RIP are performed in the same manner as before. However, the data does not include greater number of pages than that in FIG. 7, and it is assumed to take about 0.7 seconds for the PDF analysis, and about 0.8 seconds for DL generation and RIP. Then, the PDL analysis and DL generation/RIP of the next page are performed during the time before an image generated by RIP is transferred to the printing unit 101. In the present exemplary embodiment, the CPU 1031 reads the following data from the USB memory 111 at the time when operation up to RIP of the data for 5 pages is completed.

FIG. 9B is a timing chart in a case where the second reading of the data for 5 pages from the USB memory 111 is performed, and the disconnection of the USB memory 111 is detected while printing of the ninth page is in progress. In this case, the data of the USB memory 111 will be read after 5 seconds since disconnection of the USB memory 111 is detected, in consideration of performance. Although printing is temporarily stopped between the tenth page and eleventh page, printing can be resumed.

FIG. 9C is a timing chart in a case where interruption of printing is caused to be unrecognizable by the user, by detecting disconnection of the USB memory 111 at a little earlier timing than that in FIG. 9B.

Since the PDL analysis time and DL generation/RIP time are long, a time lag of a time (5 seconds) taken for transition from detection of disconnection of the USB memory 111 to detection of reconnection cannot be recognized from the user.

According to the respective exemplary embodiments as described above, even if the USB memory 111 is disconnected when data is being read from the connected USB memory 111 in the resources-saving type SFP 100, and printing of a plurality of copies is being performed, finishing printing out the specified number of sheets can be enabled.

### Other Embodiments

Additional embodiments can also be realized by a computer of a system or apparatus that reads out and executes computer-executable instructions recorded on a storage medium (e.g., computer-readable storage medium) to perform the functions of one or more of the above-described embodiment(s), and by a method, the steps of which are performed by the computer of the system or apparatus by, for example, reading out and executing the computer-executable instructions from the storage medium to perform the functions of one or more of the above-described embodiment(s). The computer may comprise one or more of a central processing unit (CPU), a micro-processing unit (MPU), and other circuitry, and may include a network of separate computers or separate computer processors. The computer-executable instructions may be provided to the computer, for example, via a network or from the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these embodiments are not limiting. The scope of the following claims is to be accorded the broadest interpretation so as to encompass all such modifications and equivalent structures and functions.

This application claims the benefit of Japanese Patent Application No. 2012-174852 filed Aug. 7, 2012, which is hereby incorporated by reference herein in its entirety.

What is claimed is:

1. An image processing apparatus, comprising:
a storage unit configured to store management information about image processing of data recorded on a recording medium connected to the image processing apparatus;
a reading unit configured to read data recorded on the recording medium;
an image processing unit configured to perform image processing on the data read by the reading unit; and
a control unit configured to control reading of the data from the recording medium and the image processing according to the management information stored in the storage unit,
wherein, in a case where it is detected that the recording medium has been disconnected and image processing of a number of times specified by the management information stored in the storage unit is not completed, the control unit causes the reading unit to read the data in response to detection of connection with the recording medium, and causes the image processing unit to execute image processing of a remaining number of times out of the specified number of times.

2. The image processing apparatus according to claim 1, wherein, in a case where it is detected that connection with the recording medium has been disconnected, the control unit instructs the image processing unit to stop the image processing, and determines whether image processing has been performed for the specified number of times based on the management information stored in the storage unit.

3. The image processing apparatus according to claim 1, wherein the control unit provides notification, in a case where connection with the recording medium is not detected within a predetermined time in a state where it is detected that connection with the recording medium has been disconnected and image processing for the number of times specified by the management information stored in the storage unit is not completed, that the image processing for the specified number of times has not been performed.

4. The image processing apparatus according to claim 1, wherein the control unit provides notification, in a case where a different recording medium is connected in a state where it is detected that connection with the different recording medium has been disconnected and image processing for a number of times specified by the management information stored in the storage unit is not completed, that image processing for the specified number of times has not been performed.

5. The image processing apparatus according to claim 1, wherein the control unit provides notification, in a case where the data is not present in the recording medium with which connection is detected in a state where it is detected that connection of the recording medium has been disconnected and image processing for a number of times specified by the management information stored in the storage unit is not completed, that image processing for the specified number of times has not been performed.

6. The image processing apparatus according to claim 1, wherein the image processing is processing for printing data stored in the connected recording medium and the specified number of times is a number of copies to print.

7. The image processing apparatus according to claim 1, wherein the recording medium is a USB memory.

8. The image processing apparatus according to claim 1, wherein the control unit causes the image processing unit to repeatedly perform image processing on data which the control unit has caused the reading unit to read for a number of times specified by the management information.

9. A control method of an image processing apparatus, comprising:
storing management information about image processing of data recorded on a recording medium connected to the image processing apparatus;
reading data recorded on the recording medium;
performing image processing on the read data;
controlling reading of the data from the recording medium and the image processing according to the stored management information; and
causing, in a case where it is detected that connection with the recording medium has been disconnected and image processing for a number of times specified by the stored management information is not completed, reading the data in response to the connection with the recording medium and execution of the image processing for a remaining number of times out of the specified number of times.

10. A storage medium storing a program for causing an image processing apparatus to execute a control method, the control method comprising:
storing management information about image processing of data recorded on a recording medium connected to the image processing apparatus;
reading data recorded on the recording medium;
performing image processing on the read data;
controlling reading of the data from the recording medium and the image processing according to the stored management information; and
causing, in a case where it is detected that connection with the recording medium has been disconnected and image processing for a number of times specified by the stored management information is not completed, reading the data in response to the connection with the recording medium and causing execution of the image processing for a remaining number of times out of the specified number of times.
